(19) United States
(12) Patent Application Publication
(10) Pub. No.: US 2012/0040751 A1
(43) Pub. Date: Feb. 16, 2012

(54) GAMING MACHINE RESERVATION SYSTEM

(75) Inventor: Colin Graham Peters, Cheltenham (AU)

(73) Assignee: IGT, Reno, NV (US)

(21) Appl. No.: 12/593,882

(22) PCT Filed: Apr. 1, 2008
(86) PCT No.: PCT/US2008/059046

§ 371 Date: Sep. 16, 2011

(30) Foreign Application Priority Data
Apr. 13, 2007 (AU) 2007901933

(51) Int. Cl. A63F 9/24

(52) U.S. Cl. 463/29

(57) ABSTRACT

Novel gaming machines and software enable a casino patron to reserve a gaming machine under certain conditions for a limited time, thereby preventing other patrons from using the machine during that time. A player using a machine (and having credit on the machine) may select a reserve machine option provided on the machine's user interface to reserve the machine for a maximum time that is determined by a reservation system that may take into account the status of the player, time, day, and other factors. Once the reservation option has been selected, reservation data is generated and printed on a ticket and stored in a database. The database may be on the gaming machine or on a host server if the gaming machine is part of a gaming network. The ticket may indicate that it is a “reservation ticket.” Once the player obtains the ticket, she may leave the gaming machine which goes into a partially disabled state such that other patrons cannot use the machine until the reservation time has expired or the ticket has been redeemed. The credit meters are reset to zero and are updated to the pre-reservation value once the ticket is inserted into the machine. The ticket may be redeemed by the player at the gaming machine (to resume play on the machine), at another machine, at a ticket redemption kiosk, at a cashier, or at a device in the gaming network having software to redeem the ticket.

### CROSS-REFERENCE TO RELATED APPLICATION

This application claims priority to Australian Provisional Patent Application No. 2007901933, filed on Apr. 13, 2007, which is hereby incorporated by reference and for all purposes.

### BACKGROUND OF THE INVENTION

1. Field of the Invention

The present invention relates to wager gaming machine control and operation. More specifically, it relates to reserving a gaming machine for a limited time while a player steps away from the machine.

2. Description of the Related Art

From the time casinos first began operating with gaming machines, certain players have believed that the element of luck has had a significant role in whether they win or lose in games of chance. Part of this belief is the ability to have a “lucky streak” at a certain machine or table, for example, with a particular dealer, and has persisted to the modern day electronic gaming machine. The concept is universal and not complicated: many players of wagering games believe in luck and may not want to leave a specific slot machine because they feel that a big payout is coming soon if they keep playing. They do not want to leave the machine out of fear that someone else will begin playing on it (and get the first player's big win). In other instances, the desire to keep playing on a gaming machine may not have to do so much with luck but more with other more worldly factors, such as proximity to refreshments or a smoking lounge, a convenient location, the ability to view other casino attractions, and the like. In fact, in many countries and jurisdictions, smoking has been or will soon be banned in casinos and gaming establishments. As a result, many players normally accustomed to being able to smoke while playing a gaming machine will have to leave the machine to smoke and, thus, risk relinquishing the machine to another player.

Previous gaming machine reservation methods and techniques have proved ineffective or have significant drawbacks that have prevented widespread acceptance and deployment. One method involved displaying a message on the machine stating that it was “reserved” but not functionally preventing another player from using the machine. That is, the message effectively requested to other patrons that they not play on this machine because another patron wishes to reserve it. However, the second patron could insert money or a player card and begin game play if desired; the message was cosmetic and did not technically prevent game play. Another method involved using player tracking cards. A player who was part of a player loyalty program could use her card to reserve a machine but issues regarding privacy and the identity of the player arose making it undesirable for such loyalty program members to use the feature.

### SUMMARY OF THE INVENTION

Novel gaming machines and software enabling a casino patron to reserve a gaming machine under certain conditions for a limited time, thereby preventing other patrons from using the machine during that time, are described. A player using a machine (and having credit on the machine) may select a reserve machine option provided on the machine's user interface (e.g., a virtual touch screen button, a mechanical button, a lever, etc.) to reserve the machine for a maximum time that is determined by a reservation system that may take into account the status of the player, time, day, and the like. Once the reservation option has been selected, reservation data is generated and printed on a ticket and stored in a database. The database may be on the gaming machine or on a host server if the gaming machine is part of a gaming network. The ticket may look identical to or very similar to a conventional cash out ticket or may have data on it indicating that it is a “reservation ticket.” Once the player obtains the ticket, she may leave the gaming machine which goes into a partially disabled state such that other patrons cannot use the machine until the reservation time has expired or the ticket has been redeemed. The ticket may be redeemed by the player at the gaming machine (to resume play on the machine), at another machine, at a ticket redemption kiosk, at a cashier, or at a device in the gaming network having software to redeem the ticket.

The gaming machine reservation software may reside entirely on the gaming machine, for example, on a network interface card (such as on a slot machine interface board or SMIB), or reside partly on the machine and partly on a host server as part of the database software for storing the reservation data. The reservation data may include a timestamp (functioning as a unique key) comprised of time and date information, a credit value, and a gaming machine identifier. When a reservation ticket is issued, the credit meters on the machine may be reset to zero and the value in the meters is recorded on the ticket and in the database. When the ticket is re-inserted into the machine, the meters on the machine are updated to reflect the amount correlated with the ticket. When the ticket issues to the user, the machine may go into a different state. For example, it may go from a fully enabled state (where the machine is fully operational and functional) to a partially disabled state (which may be referred to as a “reserve” state). In this state, the mechanism for reading a ticket may be the only peripheral that is operating. A card reader may also be operational in this state. The gaming machine monitor may display a message indicating that the machine is reserved and may provide the time until the reservation expires. When the reservation ticket is inserted into the gaming machine in a partially disabled state, the machine verifies the validity of the ticket, retrieves the relevant data (e.g., credit meter data), and transitions to a fully enabled state. It may also transition to this state if the ticket is redeemed using other means as described above. If the machine is tampered with (e.g., goes into a tilt or is manually shut down), it transitions to a fully disabled state.

In one embodiment, a method of controlling a gaming machine such that a player may reserve the machine for a limited time thereby preventing other casino patrons from using the machine is described. The status of the player is ascertained and a maximum reservation time is determined, in part based on the status of the player. The master gaming controller receives a signal that the player has selected the machine reservation option. The machine may then generate a set of reservation data. A ticket containing some or all of the reservation data is printed and provided to the player and the data is stored in a database. The gaming machine may then transition to a partially disabled state after receiving a signal from a network interface board, such as an SMIB, in the gaming machine. When the ticket is redeemed or inserted into the machine, the gaming machine transitions to a fully enabled state, thereby allowing resumption of game play. While the gaming machine is in a partially disabled state, other players who do not have the valid reservation ticket are prevented from playing the gaming machine.

In another embodiment, a gaming machine includes at least one processor, a network interface card operable to provide gaming machine reservation functionality, and credit meters. The gaming machine may be in a fully enabled state, a fully disabled state, or a partially enabled state. If it is in a partially disabled state or “reserved” state, the gaming machine is operable to accept and process a ticket and determine whether to transition the gaming machine to a fully enabled state, thereby unreserving the gaming machine. The gaming machine may have a database that stores reservation data or if the machine is part of a gaming network, the database may be on a host server. The database stores data such as gaming machine identifiers, credit data, and timestamps. Other data may also be included, such as ticket type (e.g., reservation ticket, cash out ticket, etc.)

### BRIEF DESCRIPTION OF THE DRAWINGS

References are made to the accompanying drawings, which form a part of the description and in which are shown, by way of illustration, particular embodiments:

FIG. 1 is a screen shot displayed on a monitor of a gaming machine in accordance with one embodiment;

FIG. 2 is a block diagram of a gaming machine and host server according to one embodiment;

FIG. 3 is a state diagram showing states of a gaming machine having reservation functionality in accordance with one embodiment of the present invention;

FIG. 4 is a record format diagram of a host server database in a memory that may be used to store data related to a gaming machine reservation system in accordance with one embodiment;

FIG. 5 is a flow diagram of a process for reserving a gaming machine in accordance with one embodiment of the present invention;

FIG. 6 is a flow diagram of a process of resuming game play on a reserved gaming machine in accordance with one embodiment;

FIG. 7 is a diagram of a sample reservation ticket that may be provided to a player upon reserving a gaming machine in accordance with one embodiment;

FIG. 8 is an exemplary gaming machine illustrated in perspective view; and

FIG. 9 is a partial exemplary architecture for an electronic gaming machine in accordance with one embodiment;

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order to not unnecessarily obscure the present invention.

Although the present invention is directed primarily to gaming machines and systems, it is worth noting that some of the apparatuses, systems and methods disclosed herein might be adaptable for use in other types of devices or environments, such that their use is not restricted exclusively to gaming machines and contexts. Such other adaptations may become readily apparent upon review of the inventive devices, systems and methods illustrated and discussed herein.

Systems and methods for reserving a gaming machine so that a player can use a machine, select to reserve it, and resume play on the same machine are described in the various figures. A casino patron using a specific electronic gaming machine, or other type of gaming device may want to leave the gaming machine temporarily and, upon returning, be able to continue playing on the same machine. Presently, there is no satisfactory way to reserve a gaming machine; methods involving player tracking cards (i.e., loyalty programs) have drawbacks and displaying messages has proven to be ineffectual or nonfunctional. None provide a simple, intuitive way to basically “save” a machine for a limited amount of time (e.g., time needed to go to the restroom, get refreshments, check on friends in the casino, take a break, and the like) and resume play with the same number of credits on the same machine, thereby preventing other patrons from using the machine while the player stepped away.

There are several features of a machine reservation system that may vary depending on environment and goals of the casino operator. For example, as described in further detail below, in some embodiments, the length of time that a machine can be reserved may vary depending on the type of player (e.g., member or non-member of the casino's loyalty program), time of day, day of week, location of machine, and other factors. In other embodiments, a game may be unreserved in a number of ways, for example, by inserting a ticket obtained at the time the game was reserved back into the gaming machine that issued the ticket or another gaming machine, allowing the reserve time to lapse or expire, inserting the ticket into a ticket redemption kiosk, redeeming the ticket with a cashier, or redeeming the ticket on a computing device equipped with a cash redemption application.

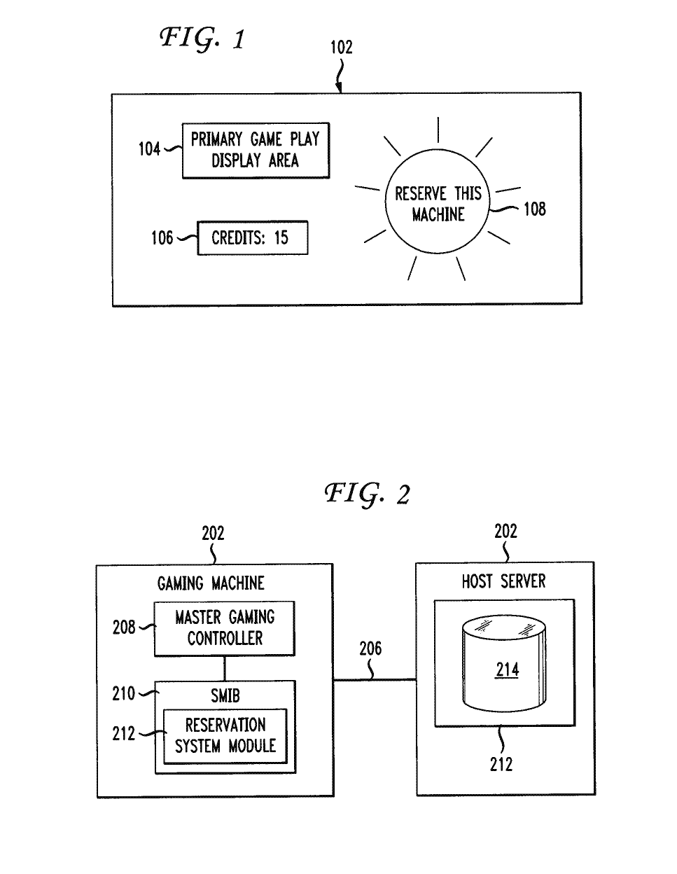

Although various embodiments of the present invention may be implemented on different types of gaming devices, to illustrate one embodiment, a gaming machine having a touch screen is used. FIG. 1 is a screen shot displayed on a monitor of a gaming machine in accordance with one embodiment. Example game and game-related displays areas are shown in a display area 102. In other embodiments, the configuration and types of information displayed may vary; the example shown in FIG. 1 is only one illustration of one embodiment and is intended to show information specifically relevant to the present invention. Display area 102 has a primary game play screen 104 where most or all of the actual game play takes place (e.g., the cards are displayed for poker or Blackjack, or the reel symbols are displayed for a slot machine type game, and so on). In some embodiments, there may be a secondary game play screen (not shown) for showing information on a bonus game, for example, or for displaying non-gaming related content (promotions, ads, etc.). A credit display area 106 shows the number of credits a player has with which to wager. Also shown in FIG. 1 in display area 102 is a reserve button area 108. In one embodiment, area 108 is a touch screen user input area or “virtual” button that the player can touch to reserve the gaming machine. For example, area 108 may contain the text “Press here to RESERVE this machine for x minutes,” “Press Here for Information on Reserving this Machine,” or simply “RESERVE THIS MACHINE!” As can be seen, there are numerous possibilities on how gaming machine reservation information and options may be conveyed to the player. In some examples, the number of minutes that the player may reserve the machine is displayed and may be determined by several factors as described below. Of course, many other types of information not particularly relevant to the present invention may be displayed in display area 102 that are not shown in FIG. 1. These other types of information may be displayed without detracting from the implementation of the various embodiments of the present invention.

In another embodiment, where the gaming machine does not have a video display monitor with touch screen functionality, the reserve button may be implemented on a physical key pad or array of buttons as a dedicated button. In another embodiment, there may be a button on a key pad or button panel on the machine that corresponds to a display on the screen (e.g., a Reserve display on the screen with a line on the display aligned with or drawn to a specific key on the panel), in this implementation a physical button may have multiple functionalities depending on what is displayed on the screen. Alternatively, a lever, switch, or any other activation device (as determined by the gaming machine or device) could be used to allow a player to reserve the gaming machine. However, regardless of the specific implementation, in one embodiment, the player may have the ability to reserve the gaming machine and the option of doing so is presented to the player via the gaming machine interface. It is worth noting that a gaming machine capable of being reserved may not always offer this option to a player (e.g., the Reserve button area may be “grayed out” or not shown at all). Whether the player is given the option to reserve may depend on various criteria as discussed below.

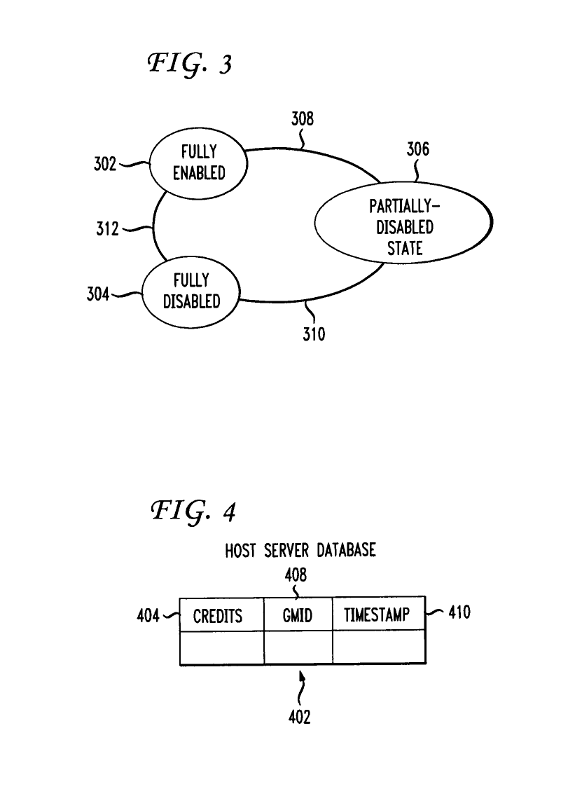

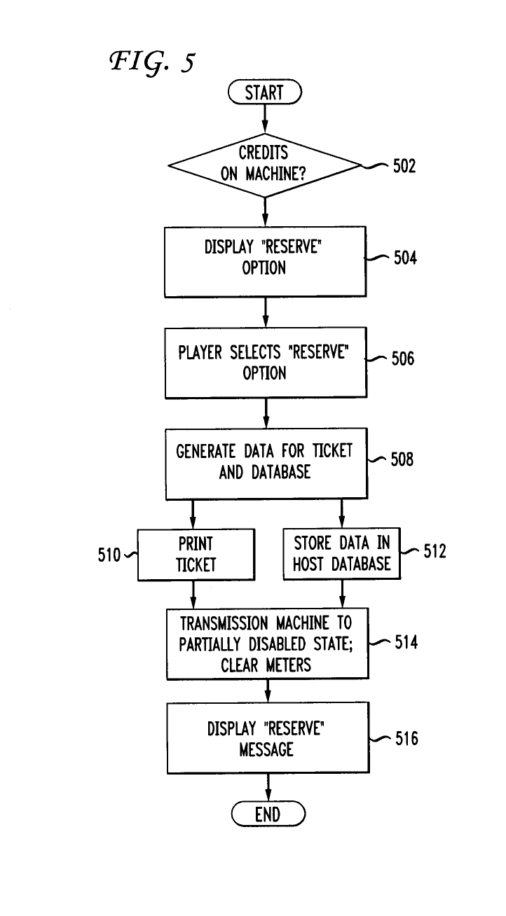

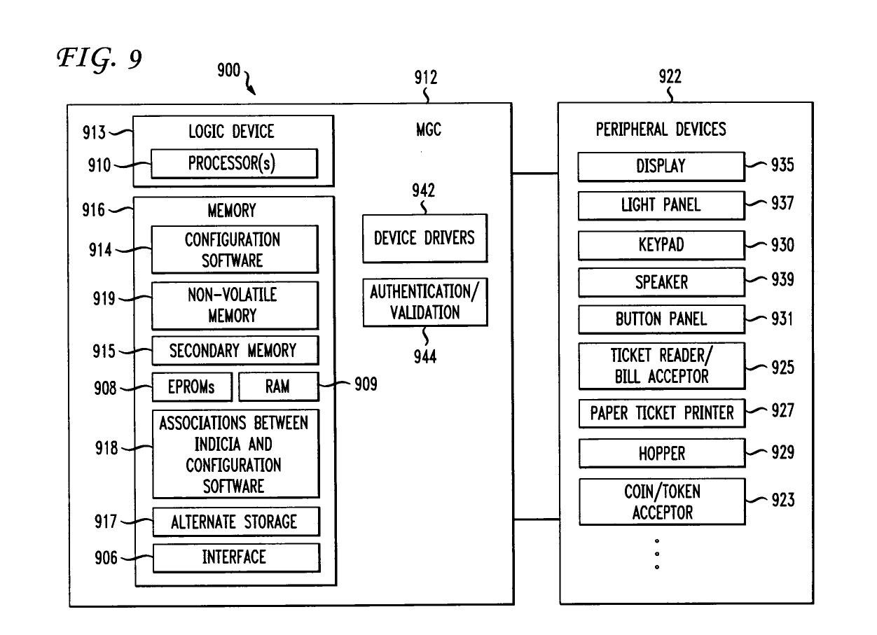

Although a more detailed description of the external and internal components of a gaming machine are provided below in FIG. 8, it is helpful to begin the detailed disclosure with an illustration of some of the basic components that may be needed to implement one embodiment of the present invention. FIG. 2 is a block diagram of a gaming machine and host server according to one embodiment. A gaming machine 202 is connected to a host gaming server 204 via a gaming network represented for simplicity by communication line 206. As noted above, gaming machine 202 may be any type of gaming device for which reservation functionality would be appropriate, such as table or counter top gaming devices and mobile or hand-held gaming devices. Gaming machine 202 has a master gaming controller (MGC) 208 that performs many of the core operations of the gaming machine, such as game play. Machine 202 (more specifically, MGC 208) may communicate with host server 204 via an interface board 210 in machine 202. In the embodiment shown, interface board 210 is referred to as a slot machine interface board or SMIB. SMIB 210 may be seen as a component external to the gaming machine that is contained within the housing of the machine. SMIB 210 is the interface to the gaming network and enables communication between the machine and host server 204, which contains a memory 212 for storing a database 214 containing reservation data, among other types of data. In other embodiments, gaming machine 202 may be a stand-alone machine and database 214 may be stored within machine 202. SMIB 210 may send signals to master gaming controller 208 to lock-up, enable, disable, and the like; that is, change states of the gaming machine as described in FIG. 3.

In one embodiment, SMIB 210 stores and executes software for the gaming machine reservation system, among software and tools for other features in the gaming machine, shown as gaming machine reservation module 212. Because module 212 is stored on SMIB 210, the software in module 212 may fall outside the scope of regulatory scrutiny and changes to it may be made by the gaming operator without running afoul of local gaming regulations. As described below, all the reservation functionality may execute from SMIB 210 which receives and transmits data from and to other sources. In another embodiment, all or part of reservation software 212 may also be stored in MGC 208, depending on the capabilities of gaming machine 202 and the needs of the gaming operator.

FIG. 3 is a state diagram showing states of a gaming machine having reservation functionality in accordance with one embodiment of the present invention. When a gaming machine is operational it is said to be in a fully enabled state 302 in which all components and peripheral devices of the gaming machine needed for game play are operational and functional. When the machine is not fully operational and is not receptive to any player input or interaction, it is in a fully disabled state 304. In this state, the machine, for example, may not play an attract sequence and may only display a message stating that the machine is not available for game play or is temporarily unavailable.

In one embodiment of the present invention, the machine may be in a state 306 which may be referred to as a reservation or partially disabled state. In state 306, the gaming machine has been reserved by a player. A message on the gaming machine monitor may state that the machine is being reserved and may specify a time. So long as it is in this state, it cannot be played by another player who may try to enter bills, coins, tokens, a player tracking card, a ticket, and the like. However, in partially disabled state 306, at least one component of the gaming machine that is operational is the ticket reader (other components may also be operational, such as the monitor, player tracking unit, and others). By keeping this component operational, the machine can accept a ticket. If a ticket is inserted and is determined to be a valid “reservation” ticket, described below, the machine is transitioned to a fully operational state 302. If it is not a valid reservation ticket, the ticket is returned to the player and the game remains in reservation state 306.

In one embodiment, the gaming machine transitions between the states according to signals from the reservation software in the SMIB and from other components in the gaming machine. As noted, the machine may go from reserved state 306 to fully enabled state 302 as shown by line 308 upon insertion of a valid reservation ticket or upon other events such as expiration of time, ticket redemption, manual intervention and others. The machine may also go from reserve state 306 to fully disabled state 304 as shown by line 310 if there is a problem detected with the machine by the gaming operator or the machine is tampered with while in reserve state 306. And, of course, the machine may transition from fully enabled state to fully disabled state and vice versa as shown by line 312 for any of a number of reasons. In other embodiments, there may be other states of a gaming machine that are not shown in FIG. 3 or there may be fewer. For example, there may not be a separate reserve state 306. The functionality of the reservation system may be invoked while the machine is in a fully disabled state by having the player enter a secret code or number from the reservation ticket using a player tracking unit, which may still be operational, to put the machine in a fully enabled state. In another example, the player may enter the secret code from the ticket into a separate component connected to the network which causes a host server to transition the machine from disabled state 304 to enabled state 302.

The gaming machine reservation system of the present invention may require generation, storage, and retrieval of various data during the course of normal operation of the machine. In one embodiment, when a player decides to reserve a gaming machine and has credit on the machine, the player presses the appropriate button (e.g., virtual, mechanical, etc.), and a ticket is printed and dispensed which the player takes with her. When this is done, information on the ticket and additional data are stored in a host server database. In another embodiment, if the gaming machine is not part of a gaming network, data may be stored in a database on the gaming machine. When the ticket is inserted back into the machine or redeemed using another means, data is checked in the system to determine the validity of the ticket with respect to the reserved machine.

FIG. 4 is a record format diagram of host server database 212 in memory 214 that may be used to store data related to a gaming machine reservation system in accordance with one embodiment. A database format 402 may have a credit field 404 for storing the number of credits on the gaming machine when the player presses the reserve button on the machine. The value stored in field 404 may be in the denomination of credits or a particular monetary value in a specific currency, depending on the machine. If the machine normally prints tickets showing the dollar amount, the value stored in field 404 may contain the monetary value where the value of a credit can vary on different machines (i.e., one credit may be 5 cents or 5 dollars depending on the machine).

Another data item that may be stored is a gaming machine identifier or GMID. A requirement in nearly all jurisdictions is that each machine has a unique identifier. The format and length of the GMID may vary depending on the jurisdiction. A GMID field 408 stores a unique gaming machine identifier. A timestamp field 410 stores a value that uniquely identifies the ticket. In one embodiment, the timestamp value is comprised of the date and time the ticket was issued and the GMID of the machine. For example, for a ticket issued at 11:39:26 am (26 seconds after 11:39 am) on Jan. 7, 2008 at gaming machine 58931, the timestamp identifier may be 5893111392607012008. Another number using a different order of the data items may also be used. Given that the machine will not issue two tickets at the same time, this timestamp number is expected to be unique. Other data may be stored in database 212 and there may be corresponding fields in format 400. For example, if the player is using a player tracking card or loyalty card, in one embodiment, a player identifier may also be stored in database 212. Database 212 or portions thereof described within the host server are specifically intended for a reservation system. In another embodiment, the data needed for the reservation system described herein may be stored in other databases instead of being stored in a database specifically for the reservation system. For example, a database currently used to store data on all tickets may be used to store the above information. If the gaming machine is not part of a gaming network or is not connected to a host server or the equivalent, the data may be stored in a database on the gaming machine, essentially a “tickets printed” database. Thus, when a ticket is printed as a result of a player initiating a reservation period for the gaming machine, in one embodiment, a record is created containing the monetary value on the machine at that time, the GMID of the machine, and a timestamp (utilized as a unique identifier). This record may then be used to validate the ticket at a later time.

FIG. 5 is a flow diagram of a process for reserving a gaming machine in accordance with one embodiment of the present invention. In one embodiment, software, firmware, hardware components for implementing the gaming machine reservation process (collectively “reservation system”) may be contained on an SMIB or other type of network interface board in the gaming machine described above. In other embodiments reservation software may also be stored in a host server or on both an SMIB and on a host server. For example, logic and data may reside in a host server database where the logic and data may be used to determine reservation parameters, time periods, and the like. In other embodiments, the software and firmware may be stored on other suitable components in the gaming machine. Steps of the methods shown and described herein need not be performed (and in some implementations are not performed) in the order indicated. Some implementations of the methods may include more or fewer steps than those described. At step 502 the machine reservation system determines whether the player has credits on the gaming machine. This may be done by checking a value in soft meter (or other meter) using known techniques. If there is none, in one embodiment, the player is not eligible to reserve the machine and the reserve option is not displayed to the player (e.g., a touch screen button may be “grayed out” or not displayed at all) and control returns to the beginning of the process. If there are credits available, control goes to step 504 where the reservation system causes a “Reserve” option to be displayed to the player. In another embodiment, the Reserve option may be displayed at all times but if the player has no credits available and presses the reserve button, a message may appear stating that the option is not available unless the player has credits on the machine.

At step 506 the reservation system detects that the player has selected the Reserve option either by touching the button on the screen, pressing a button on a keypad or by any other means that may be supported by the gaming machine. This may be done by having the master gaming controller send a signal to the reservation system. In one embodiment, the reservation system determines whether the player is part of a loyalty program by checking whether the player has inserted a player tracking card. If the player has, the reservation system may retrieve the player tracking number at this time. This information may be used in selecting the length of time a gaming machine may be reserved.

At step 508 the reservation system generates data that will be printed on the ticket and stored in the database. The details on the type of data include the monetary value on the machine (which may be calculated by the reservation software using the number of credits and the value of each credit), the GMID, and the timestamp. The GMID may be retrieved from the appropriate storage area in the gaming machine (e.g., a tamper-proof storage device) or may be stored persistently by the reservation software. The timestamp is generated using one or more of the data items described and may use additional data items (e.g., a randomly generated number). One of the components needed to obtain the timestamp is a clock. Most gaming machines have an internal clock that is used for various functions. The clock provides the time and date at which the reserve button was activated by the player. In one embodiment, SMIB 210 may have its own timer or clock software used for the reservation system and other systems/software on SMIB 210.

Another data item that may be generated at step 508 is the amount of time the machine may be reserved. This may be determined using one of various techniques. In the simplest embodiment, only one reservation time (e.g., 30 minutes) is allowed and is applied to all players at all times. In another simple illustration, two different reservation periods are assigned, one for loyalty program members and another for non-members, who may be assigned a shorter time period. In other embodiments, there may be multiple tiers or levels within loyalty club members (e.g., Gold, Silver, Platinum, and so on) that may determine the reservation time periods. Another factor that may be considered is the time and day of the reservation. A player may be given a greater reservation time on a weekday morning versus a weekend night. As can be seen, the gaming operator may use as many factors as desired in determining the reservation times a player is entitled to. Once the reservation time has been calculated by the reservation software, that time is stored and a countdown timer may be initiated.

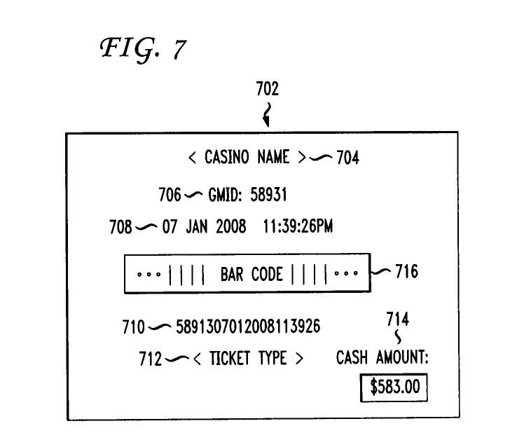

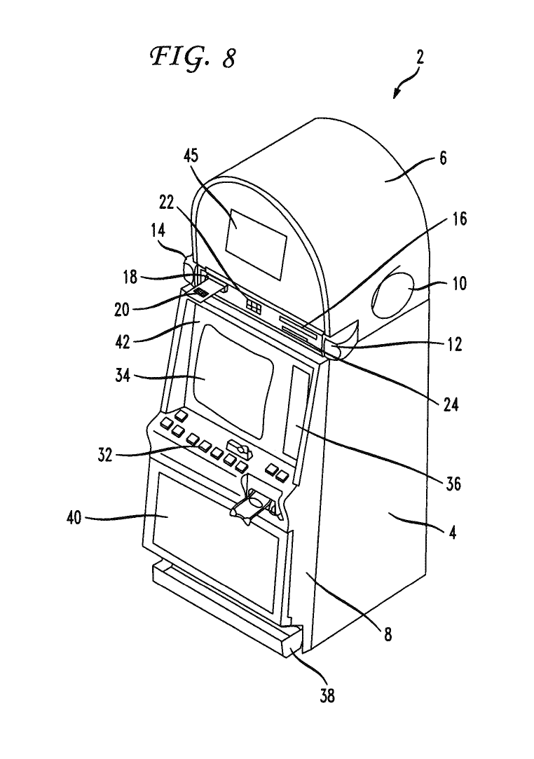

At step 510, once data for a ticket has been generated, the gaming machine prints a ticket for the player. An example of a ticket is shown in FIG. 7. In another embodiment, when the player is using a player tracking card, the data generated may be stored on the card instead of on a physical ticket. In another embodiment, data described may be generated but may not be printed on a ticket. For example, in a private or exclusive environment (e.g., for high wagering players), simply pressing the reserve button is sufficient to reserve the machine. In these cases the player may return to the machine and enter his player tracking identifier to continue playing on the machine. At step 512 the data generated at step 508 is stored in a host database if the gaming machine is in a network or, if it is a stand alone machine, in a database on the gaming machine. In another embodiment, a subset of the information generated at step 508 is stored in the database. In one embodiment, steps 510 and 512 are performed concurrently or generally at the same time; that is, once all the necessary data has been generated at step 508. In other embodiments, the data may be stored first before printing the ticket or vice versa.

At step 514 the gaming machine transitions to a partially disabled state or “reserved” state as described in FIG. 3. By step 514, the ticket has been printed and outputted from the machine's ticket dispenser and a data record corresponding to the reservation has been saved in a database on the host server (or on the gaming machine). Thus, at this stage it is safe to place the machine in a partially disabled state or fully disabled state, depending on the capabilities of the machine. In one embodiment, one operation that occurs within the machine when it enters what may be referred to as a “reservation” state is the clearing of all the appropriate hard and soft meters that contain values relating to the current player's session. For example, if a player has 25 credits and that is the amount being saved and the corresponding monetary value is being printed on the ticket, all meters that have this value are cleared. In another embodiment, the meters may not be cleared at the time of the machine changes states. Instead, the meters may be cleared when the reservation period expires, when the ticket is redeemed in some manner, or during an unexpected event, such as a tilt or manual disabling of the machine by the casino operator. At step 516 the machine displays a “Reserved” message on its monitor to inform other players that the game is being reserved. The time remaining on the countdown timer may also be displayed. For example, a message stating “Sorry, this Slot Machine is RESERVED for another patron. The Reservation will end in 47 minutes,” or something similar. The type of message to be displayed and its appearance (and placement on the monitor) may be dictated by gaming regulations and the gaming operator. At this stage the process for reserving a gaming machine is completed.

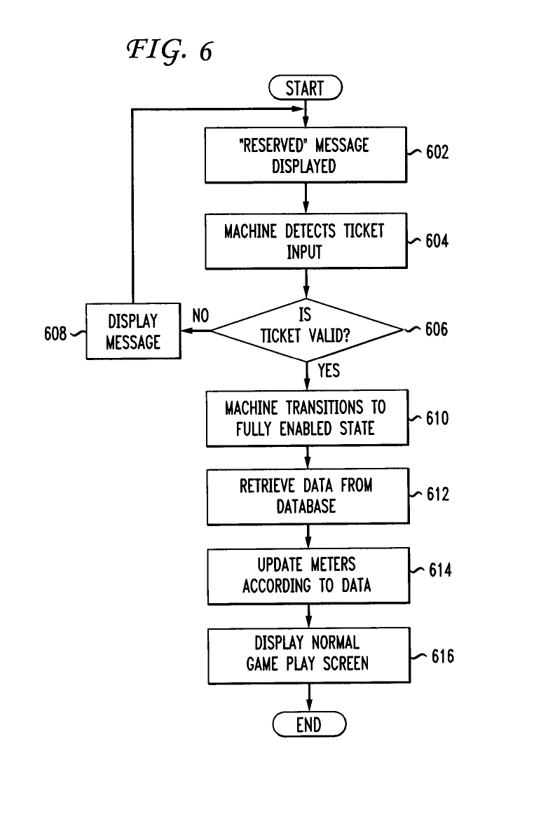

FIG. 6 is a flow diagram of a process of resuming game play on a reserved gaming machine in accordance with one embodiment. At step 602 the gaming machine is in a reserved state and displays a “reserved” message on the monitor. At step 604 the machine detects that a ticket is being inputted into the machine's ticket reader. In other embodiments, the machine may receive a message from the network that a ticket that was issued by the machine has been redeemed at another network component (e.g., another gaming machine or kiosk) or at a cashier. The machine is able to accept the ticket given that, in one embodiment, the machine's ticket reader is enabled. Other components may also be enabled, such as the video monitor and card reader.

At step 606 the machine determines whether the ticket being inserted is a valid ticket and was not already redeemed or has not expired. In one embodiment, this may be done by reading a bar code or other machine readable indicia on the ticket to obtain the timestamp or other unique ticket identifier. The reservation system transmits the timestamp data value to a host server in the gaming network so that it may be compared with reservation records in the appropriate database. As described above, a timestamp data value may be used as a unique key to records in the database. If there is a record corresponding to the timestamp value and the record has not been marked as redeemed or deleted, an acknowledgment is sent to the gaming machine's reservation system on the SMIB. By receiving this acknowledgment, the reservation system can cause the gaming machine to transition from partially disabled state to a fully enabled state at step 610. If a record for the ticket is not found in the database or it has already been redeemed, control goes to step 608 where an appropriate message is displayed on the gaming machine letting the player know, for example, that the ticket is not valid for this machine or that the ticket has expired. As noted, a reservation record may not be active because the reservation time as expired or the ticket was redeemed or used at another network component. In these instances, the gaming operator will likely not want the “reserve” message displayed on the monitor and will want the machine to be in a fully enabled state ready for game play by any casino patron.

At step 612 SMIB 212 retrieves the reservation data from the host server database and the record in the database may be deleted or moved to an expired or historical database. In another embodiment, the data may be retrieved during the validation operation at step 606. That is, if a ticket is determined to be valid, the host server may also transmit the actual data, along with the acknowledgment. In this embodiment, the gaming machine transitions to a fully enabled state and receives the reservation data concurrently. At step 614 the reservation system software transmits the reservation data to master gaming controller 208 of the gaming machine and the meters are updated accordingly. As described above, the data stored relating to credits and value may be in the form of number of credits and/or monetary value. In one embodiment, the number of credits is stored and used to adjust the meters.

Once the credit meters are updated using techniques known in the art, at step 616 the normal game play screen is displayed and the machine is ready for operation. In other embodiments, the player may also insert a loyalty program card into the machine after the machine is fully enabled. In another embodiment, the card reader is operational while the machine is in a reservation state so that the player can insert her card before inserting a ticket. If a ticket is not inserted soon after the card is inserted, the machine may dispense the card back to the player. At this stage the process of resuming game play on a reserved gaming machine is completed.

FIG. 7 is a diagram of a sample reservation ticket that may be provided to a player upon reserving a gaming machine in accordance with one embodiment. As with many tickets, a ticket 702 has the gaming operator or casino name 704 at the top. Ticket 702 also has information and data that are human readable and machine readable, typically in the form of a bar code 716. In one embodiment the format of bar code 716 is printed according to LAB (NSW) specifications. In other embodiments ticket 702 is implemented in media other than a convention paper ticket. Other implementations may include a smart card that stores credit card and other media. The human-readable information may include a GMID 706, date of the ticket and the time it was printed or created in the machine 708, a unique identifier (referred to as a timestamp above) 710, a cash amount 714, and a ticket type 712. For example, ticket 702 may have printed on it text indicating that it is a ticket issued as a result of reserving a gaming machine (a “reservation” ticket) and may also provide the length of the reservation.

In one embodiment, bar code 716 may contain only the unique identifier or timestamp which may be the only information the gaming machine initially requires to determine whether the ticket is valid (e.g., using the timestamp data value to search the database). All the other information, such as value or number of credits may be obtained from the reservation record in the database that is transmitted to the gaming machine. In other embodiments, bar code 716 or other machine-readable indicia stores other data that may be used to either search the database or may be used to resume game play on the machine once it is in a fully enabled state. Of course, other types of data may be on ticket 702 and the data items described here are not all necessary for implementing embodiments of the invention. For example, ticket 702 may only contain bar code 716 and cash amount value 714. There are numerous other ticket formats that may be used. The human and machine readable data on the ticket may vary widely. As noted, ticket 702 may be labeled as a reservation ticket or other type or may not have a label or type and simply be a convention ticket indicating a monetary value

FIG. 8 is an exemplary gaming machine is illustrated in perspective view. Gaming machine 10 includes a top box 11 and a main cabinet 12, which generally surrounds the machine interior (not shown) and is viewable by users. This top box and/or main cabinet can together or separately form an exterior housing adapted to contain a plurality of internal gaming machine components therein. Main cabinet 12 includes a main door 20 on the front of the gaming machine, which preferably opens to provide access to the gaming machine interior. Attached to the main door are typically one or more player-input switches or buttons 21, one or more money or credit acceptors, such as a coin acceptor 22 and a bill or ticket validator 23, a coin tray 24, and a belly glass 25. Viewable through main door 20 is a primary video display monitor 26 and one or more information panels 27. The primary video display monitor 26 will typically be a cathode ray tube, high resolution flat-panel LCD, plasma/LED display or other conventional or other type of appropriate video monitor. Alternatively, a plurality of gaming reels can be used as a primary gaming machine display in place of display monitor 26, with such gaming reels preferably being electronically controlled, as will be readily appreciated by one skilled in the art.

Top box 11, which typically rests atop of the main cabinet 12, may contain a ticket printer 28, a key pad 29, one or more additional displays 30, a card reader 31, one or more speakers 32, a top glass 33, one or more cameras 34, and a secondary video display monitor 35, which can similarly be a cathode ray tube, a high resolution flat-panel LCD, a plasma/LED display or any other conventional or other type of appropriate video monitor. Alternatively, secondary display monitor 35 might also be foregone in place of other displays, such as gaming reels or physical dioramas that might include other moving components, such as, for example, one or more movable dice, a spinning wheel or a rotating display. It will be understood that many makes, models, types and varieties of gaming machines exist, that not every such gaming machine will include all or any of the foregoing items, and that many gaming machines will include other items not described above.

With respect to the basic gaming abilities provided, it will be readily understood that gaming machine 10 can be adapted for presenting and playing any of a number of gaming events, particularly games of chance involving a player wager and potential monetary payout, such as, for example, a wager on a sporting event or general play as a slot machine game, a keno game, a video poker game, a video blackjack game, and/or any other video table game, among others. While gaming machine 10 can typically be adapted for live game play with a physically present player, it is also contemplated that such a gaming machine may also be adapted for game play with a player at a remote gaming terminal. Other features and functions may also be used in association with gaming machine 10, and it is specifically contemplated that the present invention can be used in conjunction with such a gaming machine or device that might encompass any or all such additional types of features and functions. Gaming machines such as these and other variations and types are made by many manufacturers, such as, for example, IGT of Reno, Nev.

With respect to electronic gaming machines in particular, the electronic gaming machines made by IGT are provided with special features and additional circuitry that differentiate them from general-purpose computers, such as a laptop or desktop personal computer. Because gaming machines are highly regulated to ensure fairness, and in many cases are operable to dispense monetary awards of millions of dollars, hardware and software architectures that differ significantly from those of general-purpose computers may be implemented into a typical electronic gaming machine in order to satisfy security concerns and the many strict regulatory requirements that apply to a gaming environment. Descriptions and examples of current gaming machine architectures can be found in a variety of references, and various discussions of hardware and software structures for an electronic gaming machine are disclosed in, for example, commonly assigned U.S. Pat. No. 6,804,763 by Stockdale, et al., entitled “High Performance Battery Backed RAM Interface;” as well as commonly assigned and co-pending U.S. patent application Ser. Nos. 10/040,239, by LeMay, et al., entitled “Game Development Architecture That Decouples The Game Logic From The Graphics Logic;” and 10/041,242, by Breckner, et al., entitled “Decoupling Of The Graphical Presentation Of A Game From The Presentation Logic,” each of which is incorporated herein in its entirety and for all purposes. A general description of many specializations in electronic gaming machines relative to general-purpose computing machines and specific examples of additional or different components and features found in such electronic gaming machines now follows.

At first glance, one might think that adapting PC technologies to the gaming industry would be a simple proposition, since both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

Accordingly, one difference between gaming machines and common PC based computers or systems is that gaming machines are designed to be state-based systems. In a state-based system, the system stores and maintains its current state in a non-volatile memory, such that in the event of a power failure or other malfunction the gaming machine will return to its current state when the power is restored. For instance, if a player were shown an award for a game of chance and the power failed before the award was provided, the gaming machine, upon the restoration of power, would return to the state where the award was indicated. As anyone who has used a PC knows, PCs are not state machines, and a majority of data is usually lost when a malfunction occurs. This basic requirement affects the software and hardware design of a gaming machine in many ways.

A second important difference between gaming machines and common PC based computer systems is that for regulation purposes, the software on the gaming machine used to generate the game of chance and operate the gaming machine must be designed as static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any change to any part of the software required to generate the game of chance, such as, for example, adding a new device driver used by the master gaming controller to operate a device during generation of the game of chance, can require a new EPROM to be burnt, approved by the gaming jurisdiction, and reinstalled on the gaming machine in the presence of a gaming regulator. Regardless of whether the EPROM solution is used, to gain approval in most gaming jurisdictions, a gaming machine must demonstrate sufficient safeguards that prevent an operator of the gaming machine from manipulating hardware and software in a manner that gives the operator an unfair or even illegal advantage over a player. The code validation requirements in the gaming industry affect both hardware and software designs on gaming machines.

A third important difference between gaming machines and common PC based computer systems is that the number and kinds of peripheral devices used on a gaming machine are not as great as on PC based computer systems. Traditionally in the gaming industry, gaming machines have been relatively simple in the sense that the number of peripheral devices and the number of functions on the gaming machine have been limited. Further, the functionality of a gaming machine tends to remain relatively constant once the gaming machine is deployed, in that new peripheral devices and new gaming software is infrequently added to an existing operational gaming machine. This differs from a PC, where users tend to buy new and different combinations of devices and software from different manufacturers, and then connect or install these new items to a PC to suit their individual needs. Therefore, the types of devices connected to a PC may vary greatly from user to user depending on their individual requirements, and may also vary significantly over time for a given PC.

Although the variety of devices available for a PC may be greater than on a gaming machine, gaming machines still have unique device requirements that differ from a PC, such as device security requirements not usually addressed by PCs. For instance, monetary devices such as coin dispensers, bill validators, ticket printers and computing devices that are used to govern the input and output of cash to a gaming machine have security requirements that are not typically addressed in PCs. Many PC techniques and methods developed to facilitate device connectivity and device compatibility do not address the emphasis placed on security in the gaming industry. To address some of these issues, a number of hardware/software components and architectures are utilized in gaming machines that are not typically found in general purpose computing devices, such as PCs. These hardware/software components and architectures include, but are not limited to, items such as watchdog timers, voltage monitoring systems, state-based software architectures and supporting hardware, specialized communication interfaces, security monitoring, and trusted memory.

A watchdog timer is normally used in IGT gaming machines to provide a software failure detection mechanism. In a normal operating system, the operating software periodically accesses control registers in a watchdog timer subsystem to “re-trigger” the watchdog. Should the operating software not access the control registers within a preset timeframe, the watchdog timer will time out and generate a system reset. Typical watchdog timer circuits contain a loadable timeout counter register to allow the operating software to set the timeout interval within a certain time range. A differentiating feature of some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. IGT gaming machines, however, typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT gaming machine game software is to use a state machine. Each function of the game (e.g., bet, play, result) is defined as a state. When a game moves from one state to another, critical data regarding the game software is stored in a custom non-volatile memory subsystem. In addition, game history or “state” information can include information regarding the amount of credits on the machine, the state of any game in progress, data regarding previous games played, amounts wagered, and so forth, any or all of which can be stored in a non-volatile memory device. This feature allows the state of the gaming machine to be recovered in the event of a substantial interruption to the gaming machine, which can include a power outage, a gaming machine reset, a critical hardware malfunction, a critical software malfunction and a gaming machine functional tilt, among other items, as will be readily appreciated. This is critical to ensure that correct wagers, credits and other important informational items are preserved.

Typically, battery backed RAM devices or other similar components are used to preserve this critical data. These memory devices are not used in typical general-purpose computers. Also, the software structure on the gaming machine can include a safe storage manager module that is configured to update the overall state of the gaming machine to the non-volatile storage component or components, preferably on a recurring basis. This safe storage manager can also be configured to restore the gaming machine to a part or all of the overall state stored at a non-volatile storage component. Further details of state based storage and recovery processes in a gaming machine are disclosed in commonly assigned U.S. Pat. No. 6,804,763, which is again incorporated herein by reference in its entirety and for all purposes.

In addition, substantial interruptions to the gaming machine are typically monitored for by one or more system managers, such as, for example, a tilt manager. Machine properties such as power level, temperature, electrostatic level and other factors are monitored, and cautionary signals or tilt generation instructions are sent and acted upon as appropriate when one or more of these properties of the gaming machine crosses a set tolerance level for whatever reason. Details of such property monitoring and tilt generation processes in a gaming machine are disclosed in commonly assigned and co-pending U.S. patent application Ser. No. 09/954,816, by Breckner, et al., entitled “Modular Tilt Handling System,” which is incorporated herein by reference in its entirety and for all purposes.

Continuing further, IGT gaming computers normally contain additional interfaces, including serial interfaces, to connect to specific subsystems internal and external to the gaming machine. The serial devices may have electrical interface requirements that differ from the “standard” EIA RS232 serial interfaces provided by general-purpose computers. These interfaces may include EIA RS485, EIA RS422, Fiber Optic Serial, optically coupled serial interfaces, current loop style serial interfaces, and the like. In addition, to conserve serial interfaces internally in the gaming machine, serial devices may be connected in a shared, daisy-chain fashion where multiple peripheral devices are connected to a single serial channel.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this. In addition, security monitoring circuits detect intrusion into an IGT gaming machine by monitoring security switches attached to access doors in the gaming machine cabinet. Preferably, access violations result in suspension of game play and can trigger additional security operations to preserve the current state of game play. These circuits also function when power is off by use of a battery backup. In power-off operation, these circuits continue to monitor the access doors of the gaming machine. When power is restored, the gaming machine can determine whether any security violations occurred while power was off, such as by software for reading status registers. This can trigger event log entries and further data authentication operations by the gaming machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the gaming machine. The code and data stored in these devices may include, for example, authentication algorithms, random number generators, authentication keys, operating system kernels, and so forth. The purpose of these trusted memory devices is to provide gaming regulatory authorities a root trusted authority within the computing environment of the gaming machine that can be tracked and verified as original. This may be accomplished via removal of the trusted memory device from the gaming machine computer and verification of the secure memory device contents is a separate third party verification device. Once the trusted memory device is verified as authentic, and based on the approval of verification algorithms contained in the trusted device, the gaming machine is allowed to verify the authenticity of additional code and data that may be located in the gaming computer assembly, such as code and data stored on hard disk drives.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. In addition to the basic gaming abilities provided, these and other features and functions serve to differentiate gaming machines into a special class of computing devices separate and distinct from general purpose computers.

FIG. 9 is a simplified block diagram of another embodiment of an example gaming machine 900 in accordance with a specific embodiment of the present invention. As illustrated in the embodiment of FIG. 9, gaming machine 900 includes at least one processor 910, at least one interface 906, and memory 916.

In one implementation (not shown), processor 910 and master gaming controller 912 are included in a logic device 913 enclosed in a logic device housing. In the implementation shown in FIG. 9, processor 910 is in logic device 913 which, together with other components described below, are in master gaming controller 912. Processor 910 may include any conventional processor or logic device configured to execute software allowing various configuration and reconfiguration tasks such as, for example: a) communicating with a remote source via communication interface 906, such as a server that stores authentication information or games; b) converting signals read by an interface to a format corresponding to that used by software or memory in the gaming machine; c) accessing memory to configure or reconfigure game parameters in memory according to indicia read from the device; d) communicating with interfaces, various peripheral devices 922 and/or I/O devices 911; e) operating peripheral devices 922 such as, for example, card reader 925 and paper ticket reader 927; f) operating various I/O devices such as, for example, display 935, key pad 930 and a light panel 916; etc. For instance, processor 910 may send messages including configuration and reconfiguration information to display 935 to inform casino personnel of configuration progress. As another example, logic device 913 may send commands to light panel 937 to display a particular light pattern and to speaker 939 to project a sound to visually and aurally convey configuration information or progress. Light panel 937 and speaker 939 may also be used to communicate with authorized personnel for authentication and security purposes.

Peripheral devices 922 may include several device interfaces such as, for example: card reader 925, bill validator/paper ticket reader 927, hopper 929, etc. Card reader 925 and bill validator/paper ticket reader 927 may each comprise resources for handling and processing configuration indicia such as a microcontroller that converts voltage levels for one or more scanning devices to signals provided to processor 910. In one embodiment, application software for interfacing with peripheral devices 922 may store instructions (such as, for example, how to read indicia from a portable device) in a memory device such as, for example, non-volatile memory, hard drive or a flash memory.

Gaming machine 900 also includes memory 916 which may include, for example, volatile memory (e.g., RAM 909), non-volatile memory 919 (e.g., FLASH memory, EPROMs, battery backed RAM, etc.), unalterable memory (e.g., EPROMs 908), alternate storage 917 (e.g., non-volatile memory implemented using disk drive(s), flash memory, remote storage, etc.), etc. The memory may be configured or designed to store, for example: 1) configuration software 914 such as all the parameters and settings for a game playable on the gaming machine; 2) associations 918 between configuration indicia read from a device with one or more parameters and settings; 3) communication protocols allowing processor 910 to communicate with peripheral devices 922 and I/O devices 911; 4) a secondary memory storage device 915 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. Typically, the master gaming controller 912 communicates using a serial communication protocol. A few examples of serial communication protocols that may be used to communicate with the master gaming controller include but are not limited to USB, RS-232 and Netplex (a proprietary protocol developed by IGT, Reno, Nev.).

A plurality of device drivers 942 may be stored in memory 916 or separately as shown. Example of different types of device drivers may include device drivers for gaming machine components, device drivers for peripheral components 922, etc. Typically, device drivers 942 utilize a communication protocol of some type that enables communication with a particular physical device. The device driver abstracts the hardware implementation of a device. For example, a device driver may be written for each type of card reader that may be potentially connected to the gaming machine. Examples of communication protocols used to implement device drivers 959 include Netplex 960, USB 965, Serial 970, Ethernet 975, Firewire 985, I/O debouncer 990, direct memory map, serial, PCI 980 or parallel. Netplex is a proprietary IGT standard while the others are open standards. According to a specific embodiment, when one type of a particular device is exchanged for another type of the particular device, a new device driver may be loaded from memory 916 by processor 910 to allow communication with the device. For instance, one type of card reader in gaming machine 900 may be replaced with a second type of card reader where device drivers for both card readers are stored in the memory 916.

In some embodiments, gaming machine 900 may also include various authentication and/or validation components 944 which may be used for authenticating/validating specified gaming machine components such as, for example, hardware components, software components, firmware components, information stored in the gaming machine memory 916, etc.

In some embodiments, the software units stored in the memory 916 may be upgraded as needed. For instance, when the memory 916 is a hard drive, new games, game options, various new parameters, new settings for existing parameters, new settings for new parameters, device drivers, and new communication protocols may be uploaded to the memory from the master gaming controller 104 or from some other external device. As another example, when the memory 916 includes a CD/DVD drive including a CD/DVD designed or configured to store game options, parameters, and settings, the software stored in the memory may be upgraded by replacing a first CD/DVD with a second CD/DVD. In yet another example, when the memory 916 uses one or more flash memory 919 or EPROM 908 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

While the invention has been particularly shown and described with reference to specific embodiments thereof, it will be understood by those skilled in the art that changes in the form and details of the disclosed embodiments may be made without departing from the spirit or scope of the invention. However, it will be understood that embodiments in which such games are developed without such templates are within the scope of the invention. In addition, the host of a game development environment implemented according to the present invention does not necessarily need to be a gaming machine provider or manufacturer to remain within the scope of the invention. And as discussed above, any of a wide range of technologies may be employed to implement and provide access to such a game development environment.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method of controlling a gaming machine comprising:
receiving a first signal indicating that the player has selected to reserve the gaming machine;
ascertaining a status of a player;
generating a set of data relating to a reservation;
printing a ticket containing at least a subset of the first set of data;
storing the first set of data in a database;
transitioning the gaming machine to a partially disabled state after receiving a second signal from a network interface board in the gaming machine, thereby placing the gaming machine in a reserved state and preventing game play; and
transitioning the gaming machine to a fully enabled state after receiving a valid reservation ticket, thereby allowing resumption of game play;
wherein while the gaming machine is in the partially disabled state, other players who do not have the valid reservation ticket are prevented from playing the gaming machine.

2. A method as recited in claim 1, wherein transitioning the gaming machine to a fully enabled state is done by one of expiration of a reservation time, redemption of the valid reservation ticket into a ticket redemption kiosk in a gaming network, redemption of the valid reservation ticket with a cashier, redemption of the valid reservation ticket on a computing device equipped with a cash redemption application in the gaming network, and by receiving a code entered by a player into the gaming machine to resume game play, wherein the code was provided to the player at the time the player reserved the gaming machine.

3. A method as recited in claim 1 or claim 2, wherein a partially disabled state functionality is included in a fully disabled state functionality.

4. A method as recited in any of claims 1 through 3, wherein the database has a credit meter amount field, a gaming machine identifier field, and a timestamp field.

5. A method as recited in any of claims 1 through 4, wherein the gaming machine is a gaming table or a mobile gaming device.

6. A method as recited in any of claims 1 through 5, wherein transitioning the gaming machine to a partially disabled state further comprises clearing one or more meters in the gaming machine.

7. A method as recited in any of claims 1 through 6, wherein resuming game play on the gaming machine further includes updating the value of one or more meters according to the first set of data stored in the database.

8. A method as recited in any of claims 1 through 7, further comprising displaying a message on a monitor of the gaming machine indicating that the gaming machine is reserved, wherein placement of the message is dictated by gaming regulations.

9. A method as recited in any of claims 1 through 8, wherein ascertaining the status of the player further comprises reading data from a player tracking card inserted into the gaming machine.

10. A method as recited in any of claims 1 through 9, further comprising determining whether a ticket being inserted into the gaming machine has not been redeemed at another network component or at a casino cashier.

11. A method as recited in any of claims 1 through 10, wherein transitioning the gaming machine to a fully enabled state further comprises:
obtaining a timestamp value from the ticket; and
comparing the timestamp value with data stored in the database to determine if there is a record corresponding to the timestamp.

12. A method as recited in any of claims 1 through 11, wherein the ticket may also contain a ticket type and a time value related to the reservation.

13. A method as recited in any of claims 1 through 12, wherein the database is in a host server.

14. A method as recited in any of claims 1 through 13, wherein the database is in the gaming machine.

15. A method as recited in any of claims 1 through 14, further comprising deriving a maximum reservation time based on the player status.

16. A method as recited in claim 15, wherein the maximum reservation time is the same for all players.

17. A method as recited in claim 16, wherein deriving the maximum reservation time further comprises examining one of time and day at which a reservation is requested and a gaming machine location.

18. A method as recited in claim 16, further comprising displaying the maximum reservation time on a gaming machine monitor.

19. A gaming machine comprising:
at least one processor;
a network interface card operable to provide gaming machine reservation functionality;
one or more credit meters; and
wherein the gaming machine is in one of a fully enabled state, a fully disabled state, and a partially enabled state, wherein when in the partially enabled state, the gaming machine is operable to accept and process a ticket and determine whether to transition the gaming machine to a fully enabled state, thereby transitioning the gaming machine from being reserved to available for game play.

20. A gaming machine as recited in claim 19, further comprising a memory for storing reservation data.

21. A gaming machine as recited in claim 19 or claim 20, wherein the reservation data includes a credit meter amount field, a gaming machine identifier field, and a timestamp field.

22. A gaming machine as recited in any of claims 19 through 21, further comprising a means for enabling a user to select to reserve the gaming machine.

23. A gaming machine as recited in any of claims 19 through 22, wherein the network interface card includes a gaming machine reservation module.

24. A gaming machine as recited in claim 23 wherein the gaming machine reservation module includes a maximum reservation time calculation module.

25. A gaming network comprising:
a host server having a memory storing gaming machine reservation data, including credit meter values, gaming machine identifiers, and timestamp values; and
a gaming machine having a network interface card operable to provide gaming machine reservation functionality, wherein the gaming machine is in one of a fully enabled state, a fully disabled state, and a partially enabled state, wherein when in the partially enabled state, the gaming machine is operable to accept and process a ticket and determine whether to transition the gaming machine to a fully enabled state, thereby transitioning the gaming machine from being reserved to available for game play.
